(19) United States
(12) Patent Application Publication
(10) Pub. No.: US 2026/0141290 A1
(43) Pub. Date: May 21, 2026

(54) AI-BASED SECURITY EVALUATION ENGINE

(71) Applicant: UpGuard, Inc., Mountain View, CA (US)

(72) Inventors: Lisa Baldacchino, Brighton (AU); Keith Savage, Sydney (AU); Daniel Bradbury, Balmain (AU); Nick Jones, Northcote (AU); Jess Hooper, Thornbury (AU); Karl Malakoff, Dynnyrne (AU); Jacopo Sabbatini, Blackmans Bay (AU); Michael Franz Baukes, Geilston Bay (AU)

(21) Appl. No.: 18/954,470

(22) Filed: Nov. 20, 2024

(51) Int. Cl. H04L 9/40; G06Q 10/0635; G06Q 10/0639

(52) U.S. Cl. CPC G06N 20/00; G06Q 10/0635; G06Q 10/06395

(57) ABSTRACT

A method for generating a risk assessment for a target entity using a risk assessment system is disclosed. The risk assessment system accesses a set of documents associated with a target entity, and accesses a set of questions each associated with a risk of the target entity. The risk assessment system applies a first machine learning model to each question to produce an answer to the questions. The risk assessment system receives an output that includes a cited set of documents supporting the answer to the received set of questions. The risk assessment system applies a second machine learning model to the answer fields of the completed risk assessment to produce a readable summary associated with the target entity.

### BACKGROUND

People and organizations rely on third-party vendors to provide critical services and products. As a result, organizations must conduct risk assessments of such third-party vendors to prevent significant security risks to the contracting organization. Comprehensive risk assessments of third-party vendors are essential to safeguarding organizational assets and ensuring compliance with security standards.

Third-party vendor risk assessments apply systematic assessments to evaluate the potential risks associated with their third-party vendors. These assessments identify, analyze, and mitigate risks that could impact the organization's operations, data security, and regulatory compliance. Conducting such assessment often requires significant manual effort by multiple auditors or security personnel, resulting in an expensive and time-consuming process.

### SUMMARY

A method and risk assessment system for producing a risk assessment for a third-party vendor or target entity is disclosed. The risk assessment system accesses a set of documents of a target entity and accesses a set of questions each associated with a risk of the target entity. The risk assessment system applies a first machine learning model to each question. The risk assessment system receives an output from the first machine learning model that includes a cited set of documents supporting the answer to the received set of questions. In one embodiment, the risk assessment system applies a second machine learning model to the answer fields of the completed risk assessment to produce a readable summary of the completed risk assessment for the target entity. The risk assessment system automates the traditionally manual risk assessment process, providing a more streamlined, accurate, and efficient way for entities to manage third-party vendor risks.

### BRIEF DESCRIPTION OF THE DRAWINGS

Figure (FIG.) 1 illustrates an example system environment for a risk assessment system, in accordance with some embodiments.

FIG. 2 illustrates an example translation engine data flow, according to some embodiments.

FIG. 3 illustrates the application of one or more models to a set of translated questions and a set of documents, according to some embodiments.

FIG. 4 illustrates an example risk summary generation data flow, according to some embodiments.

FIG. 5 is a flowchart illustrating a process of analyzing a security risk associated with an entity and generating an automated summary of the security risk, according to some embodiments.

### DETAILED DESCRIPTION

Figure (FIG.) 1 illustrates an example system environment for a risk assessment system 100, in accordance with some embodiments. The system environment illustrated in FIG. 1 includes the risk assessment system 100, a target entity 110, and a requesting entity 120, communicatively coupled by the network 125. As described herein, the risk assessment system 100 performs one or more risk assessment operations, for instance by assessing one or more risks or liabilities associated with the target entity 110 at the request of the requesting entity 120. Alternative embodiments of the system environment of FIG. 1 may include more, fewer, or different components from those illustrated in FIG. 1, and the functionality of each component may be divided between the components differently from the description below.

A risk assessment system 100 is configured to perform one or more risk assessment operations, for instance targeting the target entity 110 on behalf or at the request of the requesting entity 120. The risk assessment system 100 includes a generative content module 130, a document engine 135, a security profile module 140, a model serving system 150, a model database 155, an interface system 160, a translation engine 170, a pre-population engine 180, and a report generation module 190. In other embodiments, the risk assessment system 100 can include fewer, additional, or different components than illustrated in the embodiment of FIG. 1.

A target entity 110 refers to an external entity or organization that provides products or services to the requesting entity 120. A target entity 110 may be a service provider to provide specialized services (e.g. cloud computing, data storage, IT support, cybersecurity, or legal services). A target entity 110 may also be a contracting firm tasked with specific tasks or projects (e.g., software development, or marketing campaigns).

A requesting entity 120 is an online computing system that is associated with an entity. An entity may be a person or an organization (e.g., a business, a charity, or a school). The requesting entity 120 requests a third party risk assessment for a target entity 110. The requesting entity 120 may rely on the target entity 110 to provide critical services and products, and thus may require that the target entity satisfy a set of security or risk requirements. The requesting entity 120 may require that risk assessments of target entities 110 be conducted prior to engaging with the target entities in order to identify and manage the risks associated with the target entities.

As used herein, a security risk can refer to a potential threat or vulnerability that could lead to unauthorized access, use, disclosure, disruption, modification, or destruction of the requesting entity's 120 information, capabilities, functionalities, systems, or assets. Security risks may pose a significant threat to a requesting entity's 120 data security compliance. A target entity 110 may fail to comply with a requesting entity's 120 security practices and data protection measures, for instance by failing to provide documentation detailing a proper data privacy policy of the target entity 110.

A network 125 communicatively couples the risk assessment system 100, the target entity 110, the requesting entity 120, and the components of through one or more sub-networks, which may include any combination of the local area and/or wide area networks, using both wired and/or wireless communication systems. In one embodiment, a network 125 uses standard communications technologies and/or protocols. For example, a network 125 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 125 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 125 may be represented using any suitable format, such as hypertext markup language (HTML), extensible markup language (XML), JavaScript object notation (JSON), structured query language (SQL). In some embodiments, all or some of the communication links of a network 125 may be encrypted using any suitable technique or techniques such as secure sockets layer (SSL), transport layer security (TLS), virtual private networks (VPNs), Internet Protocol security (IPsec), etc. The network 125 also includes links and packet switching networks such as the Internet.

A document engine 135 retrieves documentation received from the target entity 110 and accesses a set of questions associated with evaluating a risk of the target entity 110 from a generated risk assessment. Documentation received from the target entity 110 can, for instance, describe the target entity's 110 security policies or any other characteristic of the target entity. Examples of such documentations can include risk assessment reports, compliance reports, policies on information security and data protection, incident breach documentation, employee headcount and identity reports, corporate business documentation, and the like. Such documentation may also include previously completed security assessment reports, and may include data organized in any suitable form or format.

The document engine 135 can access and process documents associated with the target entity 110 and the requesting entity 120 for use in generating a security assessment. In some embodiments, the document engine 135 accesses a security questionnaire associated with a risk assessment request from the requesting entity 120 for the target entity 110. The security questionnaire can be provided by the requesting entity 120, or can be accessed from another source in response to the request by the requesting entity 120. In some embodiments, the document engine 135 converts a security questionnaire associated with a risk assessment for a target entity 110 into a set of questions that can be provided to a large language model for answering. The document engine 135 can extract information from the accessed documents associated with the target entity 110 and can store the extracted information within a security profile associated with the target entity, via the security profile module 140. For instance, the document engine 135 can process an employee overview document, can extract the number of employees, the geographic locations of each employee, and the title of each employee from the employee overview document, and can populate a corresponding portion of the security profile associated with the target entity with the extracted employee information.

The document engine 135 likewise can retrieve documents from the target entity 110 relevant to the requested risk assessment for use in generating answers to the questions within a security questionnaire. Such questions can include questions on security policies of the target entity 110, compliance and regulatory policies of the target entity, data protection policies of the target entity, incident response policies of the target entity, technical vulnerabilities associated with the target entity, risk mitigation policies or characteristics of the target entity, computer system characteristics of the target entity, or any other suitable questions associated with the evaluation of risk of the target entity. The document engine 135 may segment questions within a security questionnaire based on question subject matter or category, by number of questions, or by any other suitable characteristic. In some embodiments, the document engine 135 may access previous assessments of the target entity 110 for use in answering questions associated with the risk associated with the target entity.

A security profile module 140 can maintain, store, and update information associated with or representative of the target entity 110, the target entity's security protocols, risks associated with the target entity, or any other characteristic of the target entity. For instance, the document engine 135, as described above, can process documents associated with the target entity 110, and the security profile module 140, in response to receive the information extracted from these documents from the target entity, can create a security profile for the target entity, can store the received information within the security profile, can update an existing profile for the target entity with the received information, and the like. The security profile module 140 can likewise receive information associated with the target entity 110 from third party or external sources, and can store this information within a security profile associated with the target entity. The information stored within the security profile associated with the target entity 110 can be used by, for instance, the generative content module 130 for answering security questionnaire questions.

A model serving system 150 receives requests from the risk assessment system 100 to perform tasks related to the completion of security questionnaires, analyzing the content of documents, and producing summaries of content using machine-learned models. The tasks include, but are not limited to, natural language processing (NLP) tasks, audio processing tasks, image processing tasks, video processing tasks, generative content creation tasks, form completion tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the machine-learned models include transformer neural network architectures, large language models (LLMs), convolutional neural networks (CNNs), or any other suitable machine-learned model. For example, in embodiments where the machine-learned models include transformer models, the transformer models are coupled to receive sequential data tokenized into a sequence of input tokens and to generate a sequence of output tokens depending on a task to be performed.

The model serving system 150 receives a request including input data (e.g., text data, audio data, image data, or video data) and encodes the input data into a set of input tokens. The model serving system 150 applies one or more machine-learned models to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and may generate a sequence of output tokens that represent a response to the query. For a translation task, a transformer model may receive a sequence of input tokens that represent a paragraph in German and generate a sequence of output tokens that represents a translation of the paragraph or sentence in English. For a text generation task, a transformer model may receive a prompt and may generate text corresponding to an answer to the prompt, for instance by asking a user a response or follow-up question, or by answering a question asked by a user.

When the machine-learned model is a language model, the sequence of input tokens or output tokens is arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has a significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the risk assessment system 100 or one or more entities different from the risk assessment system 100. An LLM may be trained on a large amount of data from various data sources. For example, the data sources include websites, articles, posts on the web, and the like. From this massive amount of data coupled with the computing power of LLM's, the LLM may be able to perform various tasks and synthesize and formulate output responses based on information extracted from the training data.

In one or more embodiments, when the machine-learned model including the LLM is a transformer-based architecture, the transformer may have a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders, each of which may perform one or more attention operations.

While an LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the model server system 150 performs prompt engineering and improvement to prompts provided to a first machine-learned language model using a second machine-learned language model. In some embodiments, the model serving system 150 receives a prompt input, for instance, a question asking about a security capability of a target entity 110, and the model serving system 150 modifies the prompt using a prompt optimization model in order to structure and format the prompt in a particular way before providing the prompt to an LLM. The modified prompt may specify a prompt output format, a hallucination test, a format for answer data to be provided, and the like. In some embodiments, the model serving system 150 generates training samples based on original and modified prompts to fine-tune the second machine-learned model, to provide suggested improvements of prompts that can be used in the first machine-learned language model, and the like.

In order to perform one or more tasks requested of it, the model serving system 150 can perform various types of queries on external data, such as data associated with a target entity 110 (such as one or more policies, systems, or security services that the target entity employs), data associated with a security questionnaire (such as questions within the questionnaire), and data associated with a requesting entity 120 (such as characteristics of the requesting entity, previous security evaluations requested by the requesting entity, identities of other target entities associated with the requesting entity, and the like). Examples of tasks requested of the model serving system 150 can include answering questions (such as questions associated with a security questionnaire), text summarization (such as summarizing a security policy associated with the target entity 110), text generation (such as generating a description of the target entity), and the like, each of which may or may not require an analysis of information contained in an external dataset.

The model database 155 stores the models generated or trained by various entities (such as the model serving system 150, the generative content module 130, the report generation module 190) for subsequent use. The model database 155 ensures that the generated machine-learned models are stored securely and are readily available for deployment.

The interface system 160 provides an interface between the risk assessment system 100, the target entity 110, and the requesting entity 120, via the network 125. In addition, the interface system 160 provides an interface between components of the risk assessment system 100 and between the components of the risk assessment system and systems external to the risk assessment system. In some embodiments, the interface system 160 can generate one or more user interfaces for use by a user of a system of the environment of FIG. 1 to interact with the risk assessment system, for instance by generating a user interface that allows a user to request a security assessment of the target entity 110 and a second user interface that allows the user to review the results of the security assessment.

A translation engine 170 translates, for each question of the set of questions produced by the document engine 135, the question into a structured input comprising an identifier associated with the question, text associated with the question, a hallucination test, and an output format. A question identifier is a unique reference value assigned to each specific question within an assessment. The question text includes text from a security questionnaire or text produced by the document engine 135 that enables the model serving system 150 to answer the question to determine a risk associated a target entity 110. As an example, question text can include “1. Is there a data privacy policy in place?”.

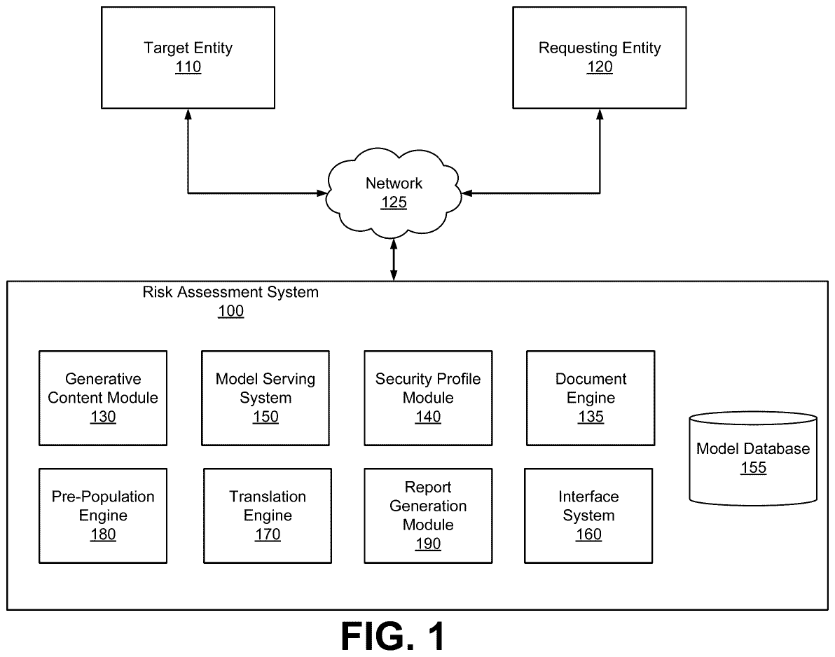

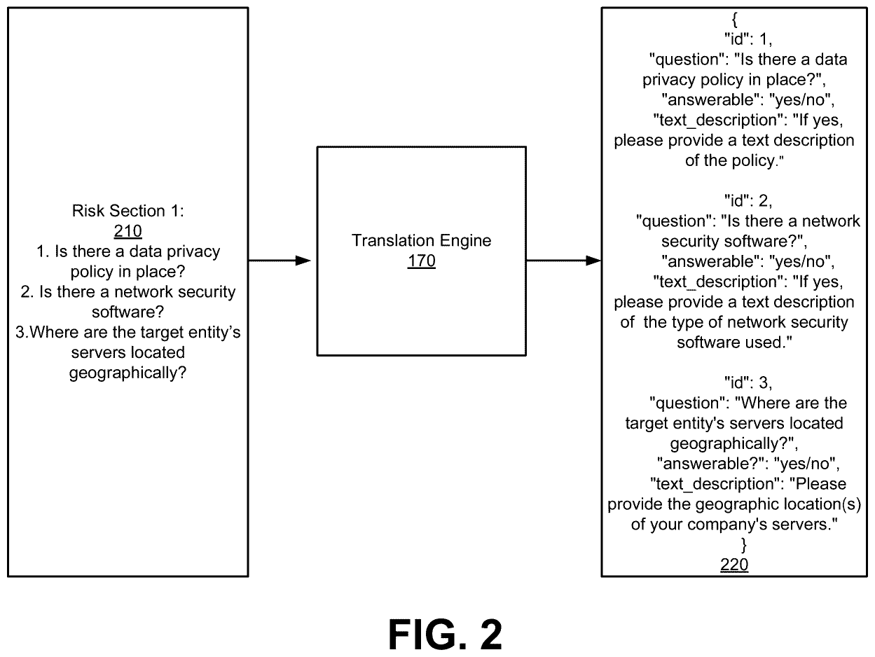

A hallucination test systematically prevents a model serving system 150 from providing fabricated information (referred to as an LLM “hallucination”) that is not supported by the information and documentation associated with the target entity 110. A hallucination test may use contradiction detection and consistency testing operations to check for consistent answers. As an example, a hallucination test may prompt a model serving system 150 with the question “is this question answerable using the provided information?” to check for consistencies and contradictions. An output format may specify the format of the response of the model serving system 150. For example, a model serving system 150 may be prompted to output answers in the JSON format. FIG. 2, described below, illustrates an example of the data flow implemented by the translation engine 170.

In one embodiment, a translation engine 170 may include instructions to prompt the model serving system 150 with a specific context setting. A context setting is designed to instruct the model serving system 150 to respond in a desired tone for responses, and a request that the answers be provided by indexes to the received set of questions. As an example, a model serving system 150 may be prompted to “Respond in a professional and authoritative tone” or “Answer this question as though completing a risk assessment”.

A pre-population engine 180 prepopulates one or more answer fields of a risk assessment or questionnaire based on the output of the model serving system 150 to produce a pre-populated risk assessment, streamlining the process of identifying information and documents associated with the target entity 110 relevant to evaluating the risk associated with the target entity. For instance, the model serving system 150 may extract relevant information regarding encryption practices from a data protection policy document, and the pre-population engine 180 pre-populates corresponding fields in the risk assessment (such as fields associated with encryption practice information) based on the response from the model serving system 150. Similarly, the pre-population engine 180 may use information from other sources (such as recent penetration test results, previously prepared risk assessments, and the like) to pre-populate fields of the risk assessment (such as fields corresponding to questions related to the target entity's vulnerability management practices). The pre-population engine 180 can also flag answers within the pre-populated risk assessment for further review by human analysts, for instance answers that don't conform to a required answer format, questions that the model serving system 150 wasn't able to answer, answers that the model serving system flagged, and the like.

The risk assessment system 100 receives a pre-populated assessment from the pre-population engine 180. The pre-populated assessment can be confirmed by an analyst to check for consistency and contradictions between the pre-populated assessment and the received documentation from the target entity 110. The risk assessment system 100 may then update the assessment based on the received analyst confirmations, answers to unanswered questions received from the analysts, and any other received feedback or edits.

In one embodiment, the risk assessment system 100 may flag risks for further review based on the updated assessment. An analyst may be notified of the risks flagged for review.

In one embodiment, the risk assessment system 100 may prompt the target entity 110 to provide more documentation information to correct or address the flagged risks based on the generated assessment report.

A report generation module 190 generates a risk assessment summarizing a set of risks associated with the target entity 110 using one or more generative content models, for instance via the generative content module 130. The report generation module 190 prompts a model serving system 150 to generate a summary of the received updated assessment, and can identify a format of the summary (e.g., sections of the risk assessment, a length of each section, a type of narrative to include in the risk assessment, and the like). A report may include one or more of a background section, sections that include summarized categories of risks associated security policies and processes, sections associated with information and asset management, sections associated with data classification and handling, sections associated with application security, sections associated with risk management, sections associated with recovery and response, and an executive summary section.

The report generation module 190 may generate a prompt to generate a summary of risks associated with each risk category and a severity of risk associated with the risk category. As an example, the report generation module 190 may prompt the model serving system 150 to generate a response “as though speaking to a cybersecurity executive, writing 2-3 paragraphs detailing security processes and policies, and focusing on HR policies, privacy policies, etc.” The generated risk assessment may include a background section to summarize characteristics of the target entity 110. For instance, the background may include details of company size, location, industry type, etc. Further, the generated report may include an executive high-level summary of the risks associated with the target entity 110. The high-level summary of the risks associated with the target entity may include a summary of the flagged risks associated with an above-threshold severity of risk.

FIG. 2 illustrates an example translation engine data flow, according to some embodiments. In FIG. 2, an assessment for a set of security risks includes questions 210 on data privacy policies, network security software, and geographic locations of a target entity's servers. The translation engine 170 translates the questions 210 to a set of structured large language model inputs 220 to prompt the model serving system 150.

The structured large language model inputs 220 each include an identifier, a question and question text, a hallucination test, and a prompt for text support from the received documentation. As an example, for the first question of the set of questions 210 (“1. Is there a data privacy policy in place?”), the translation engine 170 translates the question into the structured input: ““id”: 1, “question”: “Is there a data privacy policy in place?”, “answerable”: “yes/no”, “text_description”: “If yes, please provide a text description of the policy.” In some embodiments, the structured large language model inputs 220 can include a format and structure of an answer produced by a large language model such that the model, when prompted, produces an answer in the included format and structure.

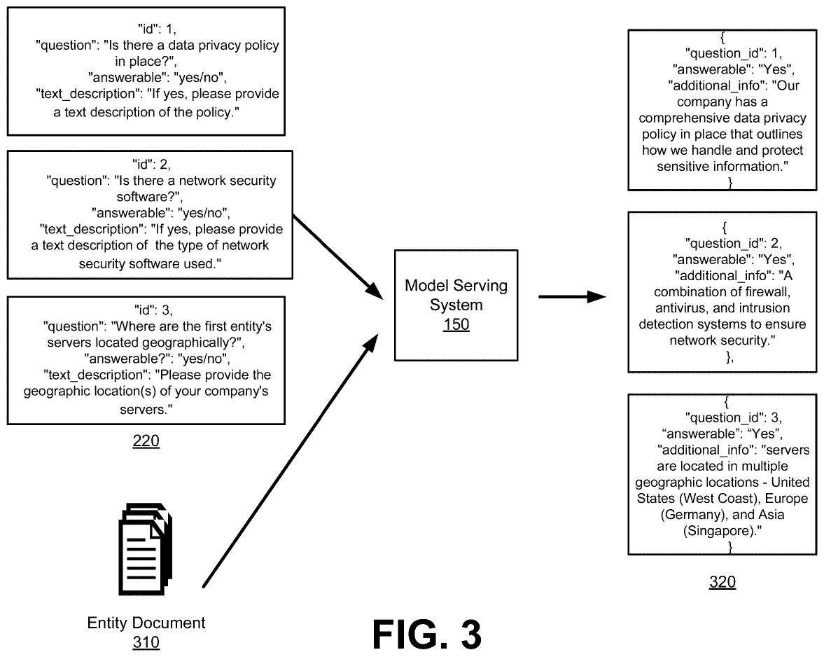

FIG. 3 illustrates the application of one or more models to a set of translated questions and a set of documents, according to some embodiments. The risk assessment system 100 prompts the model serving system 150 with the structured large language model inputs (for instance, the structured large language inputs 220 generated in FIG. 2). The model serving system 150 accesses a set of entity documents 310 from the target entity 110, and applies a large language model or other machine-learned model to structured large language inputs and the accessed set of entity documents 310 to answer the set of questions associated with the structured large language inputs.

The model serving system 150 produces a set of structured answers 320. As an example, the model serving system 150 is prompted with the structured large language input {“id”: 1, “question”: “Is there a data privacy policy in place?”, “answerable”: “yes/no”, “text_description”: “If yes, please provide a text description of the policy.”}. In response, the model serving system 150, using information from the set of entity documents 310, produces the structured answer 320 {“question_id”: 1, “answerable”: “Yes”, “additional_info”: “Our company has a comprehensive data privacy policy in place that outlines how we handle and protect sensitive information.”}.

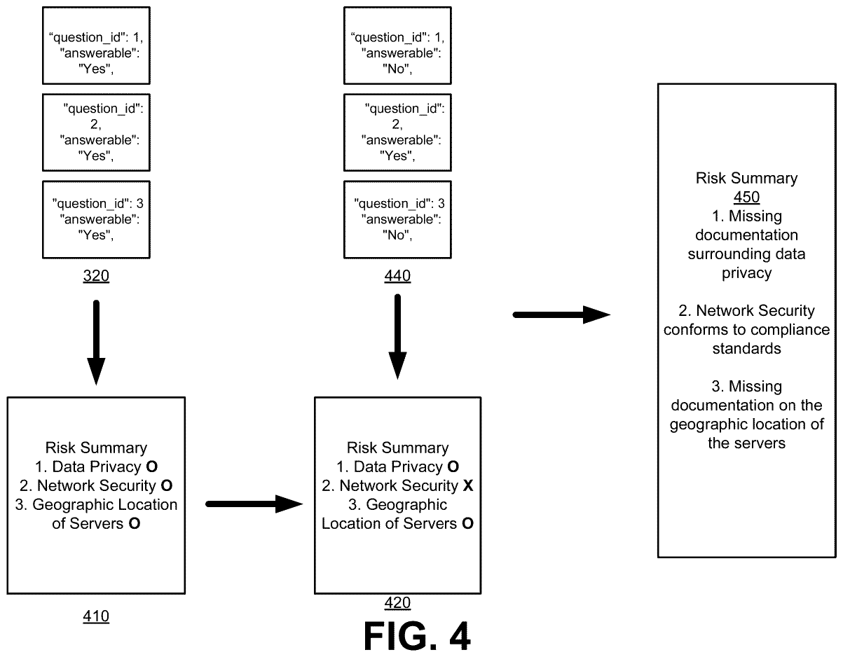

FIG. 4 illustrates an example risk summary generation data flow, according to some embodiments. In FIG. 4, the pre-population engine 180 prepopulates one or more answer fields of a risk assessment 410 using the structured answers 320 from the model serving system 150. The pre-populated risk assessment 410 may be further verified by a human analyst. The human analyst may produce updated answers 440 to the questions corresponding to the structured answers 320, and the pre-populated risk assessment 410 can be updated with the updated answers 440 to produce an updated pre-populated risk assessment 420.

Further, in FIG. 4, the report generation module 190 is prompted to generate a risk summary 450 from the updated risk assessment 420. The risk summary 450 may include a high level overview of the risks. As an example, the risk assessment system 100 pre-populates a risk assessment 410 with the information “1. Data Privacy O; 2. Network Security O; 3. Geographic Location of Servers O” based on the structured answers 320. The human analyst updates the risk assessment using updated answers 440 to produce an updated risk assessment 420, for instance to address contradictions between received documentation and the answers from the model serving system 150. In the embodiment of FIG. 4, the updated risk assessment includes the information “1. Data Privacy O; 2. Network Security X; 3. Geographic Location of Servers O”. Finally, in the embodiment of FIG. 4, a summary 450 of the updated risk assessment 420 is generated, and includes a narrative description of the information included in the updated risk assessment.

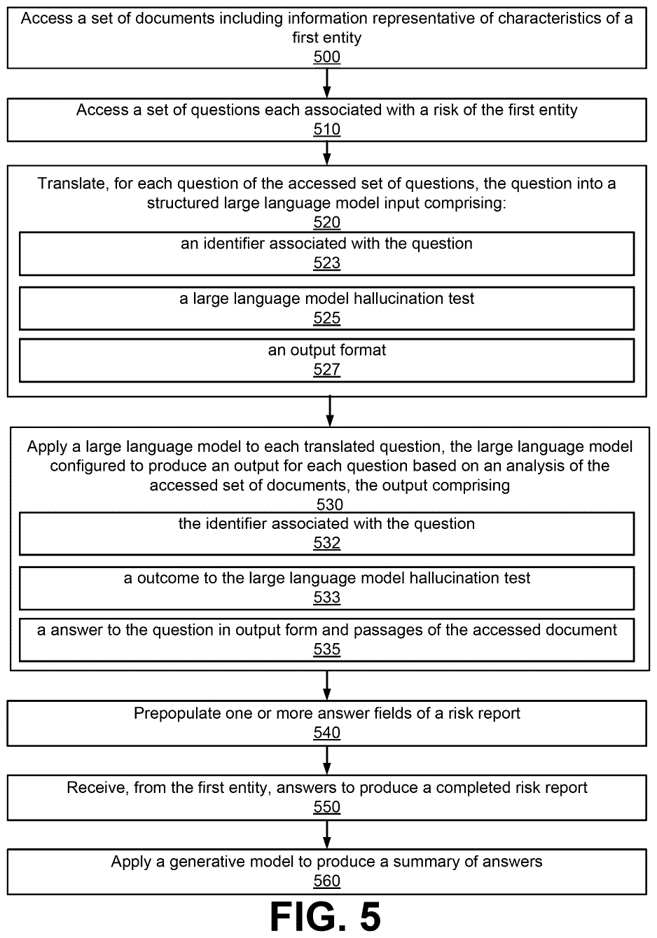

FIG. 5 is a flowchart illustrating a process of analyzing a security risk associated with an entity and generating an automated summary of the security risk, according to some embodiments. Alternative embodiments may include more, fewer, or different steps from those illustrated in FIG. 5, and the steps may be performed in a different order from that illustrated in FIG. 5. Additionally, each of these steps may be performed automatically by the risk assessment system, for instance without human intervention.

A risk assessment system accesses 500 a set of documents including information representative of characteristics of a first entity. The risk assessment system accesses 510 a set of questions associated with a risk associated with the first entity. The risk assessment system translates 520 each question of the accessed set of questions into a structured large language model input comprising: a question identifier 523, a large language model hallucination test 525, and an output format 527.

The risk assessment system applies 530 a large language model to each translated question. The large language model is configured to produce an output for each question based on an analysis of the accessed set of documents, the output comprising: the identifier associated with the question 532, an outcome of the large language model hallucination test 533, and an answer to the question in the output format and passages of the accessed document that support the answer 535.

The risk assessment system 100 prepopulates 540 one or more answer fields of a risk assessment. The risk assessment system 100 receives 550, from the first entity, answers to produce a completed risk assessment. The risk assessment system 100 then applies 560 a generative model to produce a narrative summary of the answers within the completed risk assessment.

### ADDITIONAL CONSIDERATIONS

The foregoing description of the embodiments has been presented for the purpose of illustration; it is not intended to be exhaustive or to limit the patent rights to the precise pages disclosed. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”.

What is claimed is:

1. A method comprising:
accessing a set of documents including information representative of characteristics of a first entity;
accessing a set of questions each associated with a risk of the first entity;
translating, for each question of the accessed set of questions, the question into a structured large language model input comprising:
an identifier associated with the question,
a large language model hallucination test, and
an output format;
applying a large language model to each translated question, the large language model configured to produce an output for each question based on an analysis of the accessed set of documents, the output comprising:
the identifier associated with the question,
an outcome to the large language model hallucination test,
an answer to the question in the output format, and
passages of the accessed set of documents supporting the answer to the question;
prepopulating one or more answer fields of a risk assessment based on the output of the large language model to produce a prepopulated risk assessment;
receiving, from the first entity, one or more additional answers to the answer fields of the prepopulated risk assessment to produce a completed risk assessment; and
applying a generative machine-learned model to the answer fields of the completed risk assessment to produce a summary of answers representative of content within the answer fields and the passages of the accessed set of documents supporting content within the answer fields.

2. The method of claim 1, wherein the output format comprises a JSON format including multiple choice answers in at least one JSON field.

3. The method of claim 1, wherein the large language model hallucination test comprises a test of whether the large language model can answer a question.

4. The method of claim 1, wherein a characteristic of the first entity comprises a measure of risk associated with the first entity.

5. The method of claim 1, wherein the large language model additionally identifies a risk level associated with an answer to a question.

6. The method of claim 1, wherein the summary of answers produced by the generative machine-learned model comprises a background section including information representative of the first entity, one or more risk category sections each including risk information associated with each risk category, and a summary section identifying one or more above-threshold risks.

7. The method of claim 6, wherein the risk categories comprise one or more of: security policies and processes, information and asset management, data classification and data handling, application security, risk management, and recovery and response.

8. The method of claim 1, wherein the identifier comprises a data string that uniquely identifies each question.

9. The method of claim 1, wherein the output from the large language model hallucination test is a binary answer.

10. The method of claim 1, wherein the risk assessment is a template of questions to evaluate compliance-related data from internal and external sources.

11. A non-transitory, computer-readable medium storing instructions that, when executed by a processor, cause the processor to:
access a set of documents including information representative of characteristics of a first entity;
access a set of questions each associated with a risk of the first entity;
translate, for each question of the accessed set of questions, the question into a structured large language model input comprising:
an identifier associated with the question,
a large language model hallucination test, and
an output format;
apply a large language model to each translated question, the large language model configured to produce an output for each question based on an analysis of the accessed set of documents, the output comprising:
the identifier associated with the question,
an outcome to the large language model hallucination test,
an answer to the question in the output format, and
passages of the accessed set of documents supporting the answer to the question;
prepopulate one or more answer fields of a risk assessment based on the output of the large language model to produce a prepopulated risk assessment;
receive, from the first entity, one or more additional answers to the answer fields of the prepopulated risk assessment to produce a completed risk assessment; and
apply a generative machine-learned model to the answer fields of the completed risk assessment to produce a summary of answers representative of content within the answer fields and the passages of the accessed set of documents supporting content within the answer fields.

12. The computer-readable medium of claim 11, wherein the output format comprises a JSON format including multiple choice answers in at least one JSON field.

13. The computer-readable medium of claim 11, wherein the large language model hallucination test comprises a test of whether the large language model can answer a question.

14. The computer-readable medium of claim 11, wherein a characteristic of the first entity comprises a measure of risk associated with the first entity.

15. The computer-readable medium of claim 11, wherein the large language model additionally identifies a risk level associated with an answer to a question.

16. The computer-readable medium of claim 11, wherein the summary of answers produced by the generative machine-learned model comprises a background section including information representative of the first entity, one or more risk category sections each including risk information associated with each risk category, and a summary section identifying one or more above-threshold risks.

17. The computer-readable medium of claim 16, wherein the risk categories comprise one or more of: security policies and processes, information and asset management, data classification and data handling, application security, risk management, and recovery and response.

18. The computer-readable medium of claim 11, wherein the identifier comprises a data string that uniquely identifies each question.

19. The computer-readable medium of claim 11, wherein the output from the large language model hallucination test is a binary answer.

20. The computer-readable medium of claim 11, wherein the risk assessment is a template of questions to evaluate compliance-related data from internal and external sources.
